(19) United States
(12) Patent Application Publication
(10) Pub. No.: US 2016/0132931 A1
(43) Pub. Date: May 12, 2016

(54) METHOD OF ASSOCIATING ADVERTISEMENTS TO IMAGES

(71) Applicant: Ron LEVINSON, Lapid (IL)

(72) Inventor: Ron LEVINSON, Lapid (IL)

(21) Appl. No.: 14/995,251

(22) Filed: Jan. 14, 2016

Related U.S. Application Data
(63) Continuation-in-part of application No. 13/904,049, filed on May 29, 2013, now abandoned.

(51) Int. Cl. G06Q 30/02; G06K 9/62; G06F 17/30

(52) U.S. Cl. CPC G06Q 30/0263; G06Q 30/0246; G06Q 30/0275; G06Q 30/0247; G06F 17/30265; G06K 9/6201

(57) ABSTRACT

The subject matter describes a computer-implemented method for selecting and displaying advertisements on a webpage, generating, via the server, one or more image tags associated with the image, wherein the one or more image tags are generated according to the analysis performed, providing, via the server, an advertiser user interface associated with an advertiser device for obtaining an advertisement, and at least one associated advertisement tag, and tag bid associated with the advertisement tag, generating, via the server, an advertisement tag score for the at least one advertisement tag, selecting, via the server, an advertisement for display based on the advertisement tag score and, embedding, via the server, the selected advertisement in an advertisement spot of the website and generate a revenue-per-click value to provide payment value when the advertisement is clicked upon by a viewer of the website.

### FIELD OF THE INVENTION

The subject matter relates generally to a method for matching image tags describing an image with advertisements and associating an advertisement with an image displayed on a website.

### BACKGROUND OF THE INVENTION

Advertisement material on the world-wide-web (“WWW”) is used to promote goods and services from online retailers. Advertisements that appear on a website that is logged onto by a user are determined according to cookies stored on a user's computer and according to websites the user has visited. According to the cookies an advertisement engine may determine the interests of the user and display advertisements that the user may be inclined to pursue and observe the advertisements' offers. The advertisement engine associates words from the websites the user visited with tags associated with advertisements. Some advertisement engines use words inserted by the user into a search engine, such as Google.com. The words used for searching in the search engine are used to find tags associated with advertisements that may interest the user.

The excessive amount of banners and advertisements presented on a website causes a viewer of the website to experience banner blindness. The banner blindness results from an excessive amount advertisements that the viewer is exposed to, which stimulate the viewer's senses to a point where the viewer stops noticing the advertisements or simply ignores them, even when the advertisements may interest the viewer. Some solutions provide presenting advertisements at the top of the website before presenting the actual material of the website, thus the first thing the viewer sees is the advertisements. The placement of the advertisements is then supported by a click through rate of the advertisements, where the advertisements placed at the top of the page are advertisements that are more likely to be clicked on by viewers. In some cases, an advertiser may pay the website owner to place the advertisement in the advertisement spot.

### SUMMARY

It is an object of the subject matter to disclose a computer-implemented method for selecting and displaying advertisements on a website, the method comprising scanning, by a server, a website to obtain an image and image metadata embedded in the website; analyzing, by the server, the image and the image metadata to locate characteristics identifying the image; generating, via the server, one or more image recognition image tags associated with the image, wherein the one or more image tags are generated according to an image recognition performed during the analysis of the image; generating, via the server, one or more metadata image tags associated with the image, wherein the one or more image tags are generated according to the analysis of metadata related to the image; providing, via the server, an advertiser user interface displayed on an advertiser device for obtaining an advertisement, at least one associated advertisement tag, and a tag bid value associated with the advertisement tag; receiving, at the server, the obtained advertisement from the advertiser device; generating, via the server, a bid score for each tag bid value associated with the at least one advertisement tag; generating, via the server, a click score according to a click-through-rate associated with the advertisement tag; matching, via the server, at least one advertisement tag with one or more metadata image tags associated with the image; generating, via the server, a metadata match score for each advertisement tag associated with the advertisement; matching, via the server, at least one advertisement tag with one or more image recognition image tags associated with the image; generating, via the server, an image recognition match score for each advertisement tag associated with the advertisement; generating, via the server, an advertisement tag score for the at least one advertisement tag, wherein the advertisement tag score is generated according to at least one score selected from: the metadata match score, the image recognition match score, the bid score, the click score, and a combination thereof; generating, via the server, a tag rank score associated with advertisement tag of the advertisement, according to the advertisement tag score and the tag bid value; generating, via the server, an advertisement rank score according to the tag rank scores associated with each advertisement; selecting, via the server, an advertisement for display based on the advertisement rank score; embedding, via the server, the selected advertisement in an advertisement spot of the website; said selected advertisement is viewable on the website page displayed by a viewer device; and, generating, via the server, a revenue-per-click value to provide payment when the advertisement is clicked upon by a viewer of the website.

In some cases, the server is configured to receive image tags from a website administrator device, said website administrator device is associated with a web administrator user interface for providing the image tags.

In some cases, the image tags are generated according to an object displayed in the image identified by an image recognition module.

In some cases, the advertiser user interface is associated with the advertiser device through a dedicated application.

In some cases, generation of the bid score comprises associating a scaled value to the tag bid value according to the tag bid values stored in an advertisement storage of the server.

In some cases, generating the click score comprises obtaining a click rate of the advertisement tag, said click rate is a number of times the advertisement associated with the advertisement tag was clicked by a viewer of the advertisement; obtaining an impression value of the advertisement tag, said impression value is the number of times the advertisement associated with the advertisement tag is displayed on the website; obtaining a click-through-ratio according to the click rate and the impression value; associating a scaled value with the click-through-ratio, wherein scaled value is within a predetermined range.

In some cases, generation of the metadata match score comprises determining a number of advertisement tags matching the metadata image tags of the image; generating a metadata match score based on the number of advertisement tags matching the metadata image tags of the image.

In some cases, generation of the image recognition match score comprises determining a number of advertisement tags matching the image recognition image tags of the image; generating an image recognition match score based on the number of advertisement tags matching the image recognition image tags of the image.

In some cases, generation of the revenue-per-click value is calculated based on at least one parameter selected from: an advertisement tag score, a tag rank score, an advertisement rank score and a predetermined monetary value. It is another object of the subject matter to disclose a system for selecting and displaying advertisements on a website, the system comprising a server configured to scan a website to obtain an image and image metadata embedded in the website; analyze the image and the image metadata to locate characteristics identifying the image; generate one or more image recognition image tags associated with the image, wherein the one or more image tags are generated according to image recognition analysis of the image; generate one or more metadata image tags associated with the image, wherein the one or more image tags are generated according to the analysis of metadata related to the image; provide an advertiser user interface displayed on an advertiser device for obtaining an advertisement, at least one associated advertisement tag, and a tag bid value associated with the advertisement tag; receive the obtained advertisement from the advertiser device; generate a bid score for each tag bid value associated with the at least one advertisement tag; generate a click score according to a click-through-rate associated with the advertisement tag; match at least one advertisement tag with one or more metadata image tags associated with the image; generate a metadata match score for each advertisement tag associated with the advertisement; match at least one advertisement tag with one or more image recognition image tags associated with the image; generate an image recognition match score for each advertisement tag associated with the advertisement; generate an advertisement tag score for the at least one advertisement tag, wherein the advertisement tag score is generated according to at least one score selected from: the metadata match score, the image recognition match score, the bid score, the click score, and a combination thereof; generate a tag rank score associated with advertisement tag of the advertisement, according to the advertisement tag score and the tag bid value; generate an advertisement rank score according to the tag rank scores associated with each advertisement; select an advertisement for display based on the advertisement rank score; embed the selected advertisement in an advertisement spot of the website; said selected advertisement is viewable on the website page displayed by a viewer device; and, generate a revenue-per-click value to provide payment value when the advertisement is clicked upon by a viewer of the website.

In some cases, the server is configured to receive image tags from a website administrator device, said website administrator device is associated with a web administrator user interface for providing the image tags.

In some cases, the image tags are generated according to an object displayed in the image identified by an image recognition module.

In some cases, the advertiser user interface is associated with the advertiser device through a dedicated application.

In some cases, generation of the bid score comprises associating a scaled value to the tag bid value according to the tag bid values stored in an advertisement storage of the server.

In some cases, generating the click score comprises obtaining a click rate of the advertisement tag, said click rate is a number of times the advertisement associated with the advertisement tag was clicked by a viewer of the advertisement; obtaining an impression value of the advertisement tag, said impression value is the number of times the advertisement associated with the advertisement tag is displayed on the website; obtaining a click-through-ratio according to the click rate and the impression value; associating a scaled value with the click-through-ratio, wherein scaled value is within a predetermined range.

In some cases, generation of the metadata match score comprises determining a number of advertisement tags matching the metadata image tags of the image; generating a metadata match score based on the number of advertisement tags matching the metadata image tags of the image.

In some cases, generation of the image recognition match score comprises determining a number of advertisement tags matching the image recognition image tags of the image; generating an image recognition match score based on the number of advertisement tags matching the image recognition image tags of the image.

In some cases, generation of the revenue-per-click value is calculated based on at least one parameter selected from: an advertisement tag score, a tag rank score, an advertisement rank score and a predetermined monetary value.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a computerized environment for matching image tags with advertisements, according to some exemplary embodiment of the subject matter;

FIG. 2 shows a method matching image tags to advertisements, according to some exemplary embodiments of the subject matter;

FIG. 3 shows display of an interface for connecting image tags to an image, according to some exemplary embodiments of the subject matter;

FIG. 4 shows a website display displaying an image with image tags and matching advertisements, according to some exemplary embodiments of the subject matter;

FIG. 5 shows an interface to choose a type of user that inserts an advertisement according to an image on a website, according to some exemplary embodiments of the subject matter;

FIG. 6 shows a computerized environment for embedding an advertisement into an advertisement spot on a website, according to some exemplary embodiments of the subject matter;

FIG. 7 shows a tag processor, according to some exemplary embodiments of the subject matter;

FIG. 8 shows a method for obtaining image identification tags from a website, according to some exemplary embodiments of the subject matter;

FIG. 9 shows a method for obtaining advertisement data, according to some exemplary embodiments of the subject matter;

FIG. 10 shows a method for associating an advertisement to an image, according to some exemplary embodiments of the subject matter;

FIG. 11 shows a schematic website administrator user interface displaying a summarized display of information related to advertisements displayed on the website, according to some exemplary embodiments of the subject matter.;

FIG. 12 shows a schematic website administrator user interface displaying information related to advertisement spots comprising advertisement placements, according to some exemplary embodiments of the subject matter;

FIG. 13 shows a schematic advertiser user interface displaying an advertisement campaign adding interface, according to some exemplary embodiments of the subject matter;

FIG. 14 shows a schematic advertiser user interface displaying a new advertisement addition interface, according to some exemplary embodiments of the subject matter;

FIG. 15 shows a schematic advertiser user interface displaying a campaign report summary report for an advertiser, according to some exemplary embodiments of the subject matter;

FIG. 16 shows a schematic of an advertiser user interface displaying an advertisement campaign report, according to some exemplary embodiments of the subject matter; and,

FIG. 17 shows a schematic advertiser user interface displaying a single advertisement information report, according to some exemplary embodiments of the subject matter.

### DETAILED DESCRIPTION

The subject matter discloses a method for matching image tags describing an image with advertisements displayed on a website, according to exemplary embodiments.

One technical problem dealt by the disclosed subject matter is providing an optimal advertisement in an advertisement spot of a website.

One technical solution according to the disclosed subject matter is providing a method for selecting advertisements to be displayed on a website according to a predetermined scoring and matching of advertisements with images displayed on a website. Advertisers provide advertisements with advertisements tags that are associated with the advertisements. The advertiser may provide a tag bid value associated with the advertisement tags, which is a monetary value the advertiser is willing to pay to have the advertisement displayed on the website. Image tags are generated, which describe and/or characterize an image displayed on the website. The advertisement tags are matched with the image tags to designate and display an optimal or most effective advertisement to the viewer of the website in an advertisement spot associated with the image in the website. The selection or determination of the optimal advertisement to be displayed is based on a plurality of criteria including one or more of the following parameters: a tag bid value, a match score which indicates the correlation between the image tags and the advertisement tags, a click score which indicates the amount of clicks that are associated with the advertisement tags, and a level of importance or relevance of a tag associated with an image.

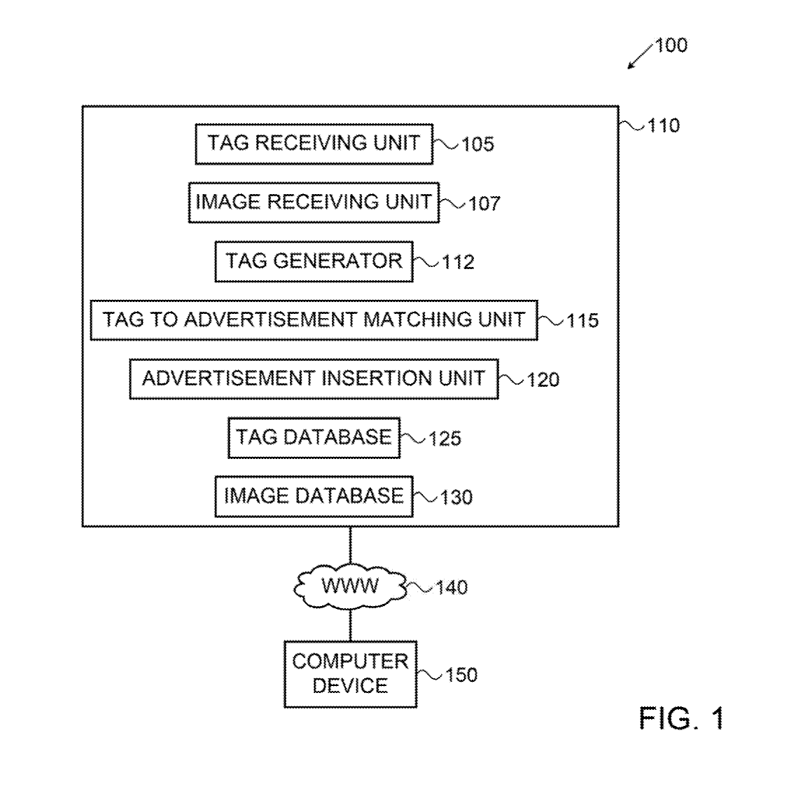

FIG. 1 shows a computerized environment for matching image tags with advertisements, according to some exemplary embodiment of the subject matter. The computerized environment 100 comprises of a server 110, which is connected to the World Wide Web (“WWW”) 140. A computer device 150 connected to the WWW 140 may access the server 110. A user of the computer device 150 inputs image tags, which comprise textual words or textual phrases that describe an image. The image tags are transmitted from the computer device 150 through the WWW 140 to the server 110. The server 110 comprises a tag receiving unit 105, which receives the image tags. The server 110 may comprise a tag generator 112, which generates the image tags describing objects located in the image. The image tags may be stored in a tag database 125, from which the tag generator 112 may obtain image tags. In some exemplary embodiments of the subject matter, the server 110 comprises an image receiving unit 107. The image receiving unit 107 may receive the image transmitted from the computer device 150 or obtained from the WWW 140, such as the server 110 receiving a hyperlink of an image location from the computer device 150. The image may be stored in an image database 130. In some cases the image is stored in the image database 130 with the image tags describing to the image.

The server 110 comprises a tag to advertisement matching unit 115, which matches the image tags with the advertisements. The tag to advertisement matching unit 115 matches at least one image tag of the image tags to an advertisement. For example, the at least one image tag is the word “ocean”. The tag to advertisement matching unit 115 matches the at least one image tag to the advertisement of a retailer of scuba diving gear, which is related to the textual word ocean, which is the image tag. In some cases, the tag to advertisement matching unit 115 provides a score to a match of the at least one image tag to the advertisement. The tag to advertisement matching unit 115 may enable the user of the computer device 150 to select the advertisement that is inserted into the website according to the score of the match.

The server 110 comprises an advertisement insertion unit 120, which inserts the advertisement obtained by the tag to advertisement matching unit 115 into the website. The advertisement inserting unit 120 may insert the advertisement into an advertisement spot on the website, for example on a right panel of the website. In some cases, the advertisement inserting unit 120 may insert the advertisement as part of the placement of the image on the website, for example as a header of the image. In some exemplary embodiments of the subject matter, the tag generator 112 may generate the image tag from the advertisement that is displayed on the website. For example, the website comprises the advertisement for scuba diving gear; the tag generator 112 may generate the tag comprising the phrase “scuba diving gear”.

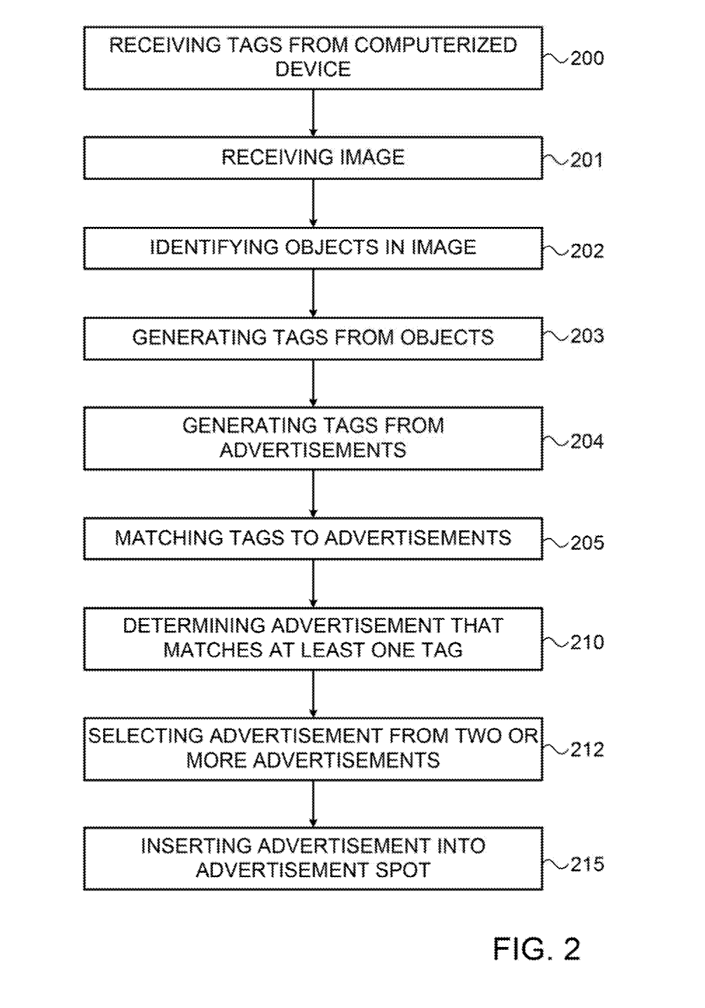

FIG. 2 shows a method for matching image tags to advertisements, according to some exemplary embodiments of the subject matter. Step 200 discloses receiving image tags from the computer device 150 of FIG. 1. The user of the computer device 150 inputs tags that describe an image. The tags are transmitted through the WWW 140 of FIG. 1 to the server 110 of FIG. 1. Step 201 discloses receiving the image. The server 110 receives the image that is displayed on a website from the computer device 150. In some cases, the server 110 receives a hyperlink address of an image location, as the website is displaying an image that is already located at another location in the WWW 140. Step 202 discloses identifying objects in the image. In some cases, the tag generator 112 of FIG. 1, identifies objects in the image. From the identified objects the tag generator 112 may generate tags. For example, the tag generator 112 identifies basketballs and basketball players in a basketball game image. Step 203 discloses generating the tags from the objects. After identifying objects in the image, the tag generator 112 generates tags that describe the objects. For example, the image is of a race car, the tag generator 112 generates tags that describe objects related to cars, such as, tires, engine oil, and the like. The server 110 may send the tags generated by the tag generator 112 to the computer device 150 to enable a user of the computer device 150 to select the tags that are most relevant. Step 204 discloses generating the image tags from advertisements. The tag generator 112 may generate tags from advertisements that are matched to other tags. Step 205 discloses matching the tags to advertisements. The tag to advertisement matching unit 115 of FIG. 1 receives the tags received by the tag receiving unit 105 and the tags generated by the tag generator 112 and searches for advertisements that are described by the tags. The tag to advertisement matching unit 115 matches advertisements according to the similarity between the tag and an advertisement's contents.

Step 210 discloses determining an advertisement that matches at least one tag of the tags. The tag to advertisement matching unit 115 may automatically select the advertisements to be inserted into the website. The advertisement may be selected by the tag to advertisement matching unit 115 according to the advertisement that matches the most tags. In some exemplary embodiments of the subject matter, the tag to advertisement matching unit 115 may generate scores to the matches made between the advertisements and to the tags. The scores may be determined according to the number of tags that match the advertisement. The scores enable the user of the computer device 150 to manually select a desired advertisement according to the match receiving the highest score. For example, the tag to advertisement matching unit 115 matches tags for the image of a cake with the advertisement of a bakery, which receives a score of 9/10 and the advertisement of a cookbook, which receives a score of 8/10. The user then selects the advertisement preferred according to the scoring of the advertisements matched by the tag to advertisement matching unit 115. Step 210 discloses selecting the advertisement from two or more advertisements. The server 110 sends the matches to the computer device 150 and the user may be able to select advertisement that the user want displayed on the website. For example the image on the website is of a cake, the user is provided an option to select a bakery advertisement or a cookbook advertisement. Step 215 discloses inserting the advertisement into an advertisement spot. The advertisement insertion unit 120 inserts the advertisement into an advertisement spot. In some cases, the advertisement spot is located as a lay seamless on the image, where the advertisement is imbedded as part of the image, for example, above the image. For example, the image is a photograph of a basketball team, and the advertisement inserted is for a basketball team's fan club. The advertisement appears as a header of the photograph of the basketball team.

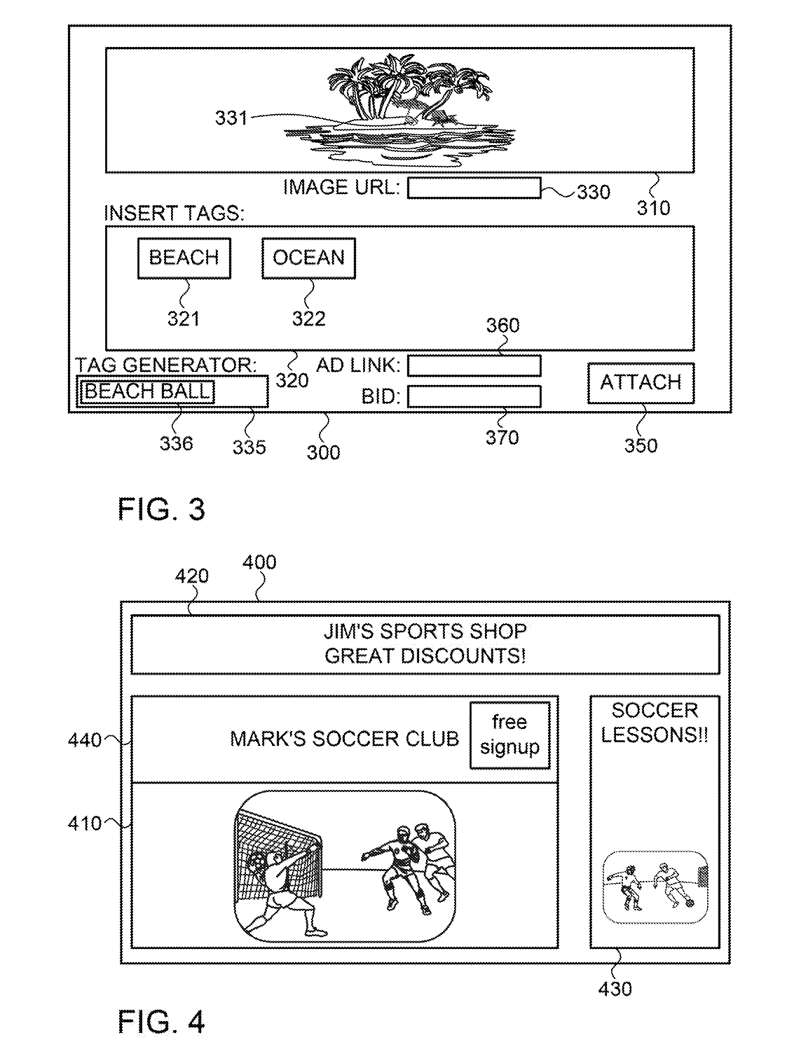

FIG. 3 shows display of an interface for connecting tags to an image, according to some exemplary embodiments of the subject matter. The interface 300 comprises an image 310 to which the tags are connected. In some exemplary embodiments of the subject matter, the interface 300 may comprise of a space for inserting an image hyperlink 330 to a WWW location in the WWW 140 of image 1. For example, the user inserts the hyperlink of the picture as www.imagestorage.com/image1234. The interface 300 comprises a tag box 320, into which tags are inserted. The tags inserted into the tag box 320 comprise textual words or phrases, for example “beach” 321 or “ocean” 322. In some exemplary embodiments of the subject matter the interface 300 may comprise a tag generator box 335, which displays tags that the server 110 of FIG. 1 generates from objects in the image 310. The tag generator 112 of FIG. 1 detects objects in the image 310, for example an object in the image is a beach ball 331 and generates a beach ball tag 336 and displays the beach ball tag 336 in the tag generator box 335. In some exemplary embodiments of the subject matter, the interface 300 enables adding an advertisement in an add link 360. For example, the user knows of an online beach supply store. The user enters the hyperlink to the online beach supply store into the add link 360, to match the advertisement to the image 310. In some cases, user that is an advertiser may insert an advertiser's bid to insert an advertiser's advertisement into the advertisement spot by entering a bid sum into a bid box 370. For example, the advertiser is a retailer of bathing suits and the advertiser wants the advertisement to display an advertiser's retail shop information. The retailer inputs the advertisement link into the add link 360, such as www.bathingsuitsdiscount.com/advertisement2. The advertiser then inputs the advertiser's bid, such as 200 dollars to have the advertisement displayed. The advertisement may be inserted into an advertisement spot where the advertiser's bid is higher than advertisement bids of other advertisers.

In some exemplary embodiments of the subject matter, the user may choose to look for images that match tags describing an advertisement. The user inputs an advertisement into the add link 360 and inserts tags describing the advertisement into the tag box 320. The tag generator 112 generates tags for the advertisements according to objects in the advertisement and displays the tags in the tag generator box 335. The server 110 locates images that match the tags describing the advertisement and inserts the images into the website. For example, the user inserting a cosmetics brand advertisement into the website. The tags of the cosmetics brand advertisement are matched to images of people using a cosmetic from a cosmetic brand featured in the cosmetics brand advertisement. The server 110 inserts the matched images into the website with the cosmetics brand advertisement.

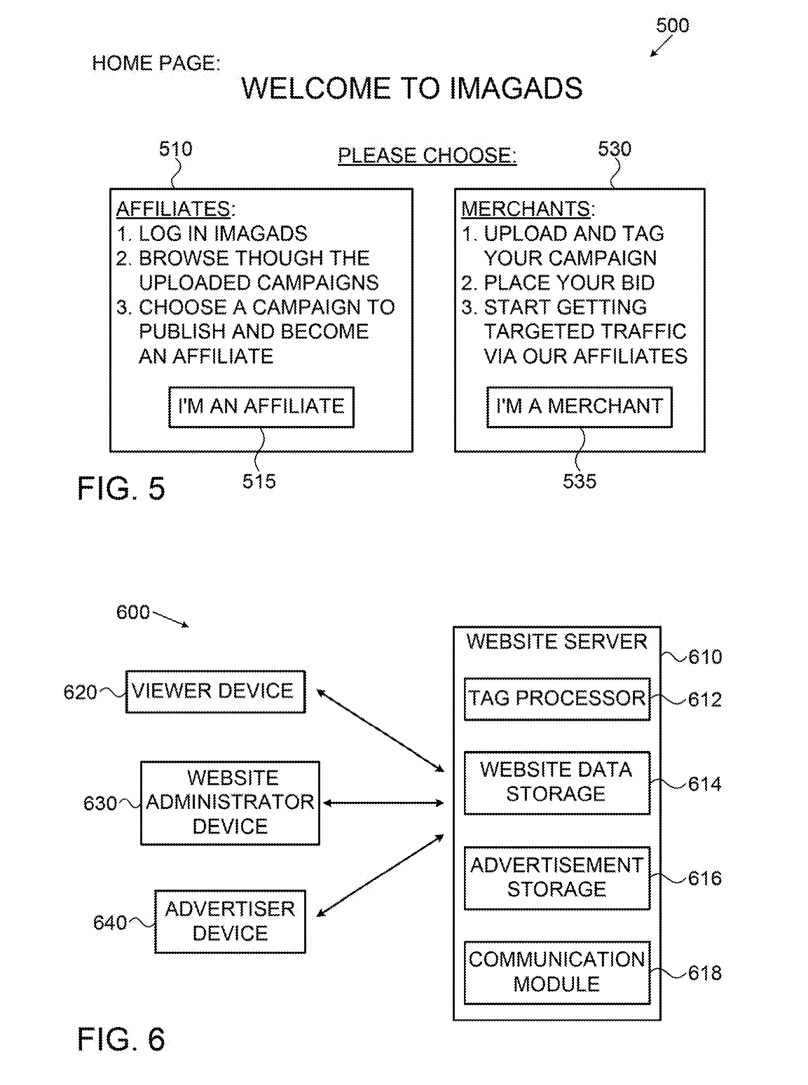

FIG. 4 shows a website display displaying an image with tags and matching advertisements, according to some exemplary embodiments of the subject matter. The website display 400 shows an image 410 with the advertisement inserted into a header advertisement spot 420, where the advertisement spot is located at the top of the website display. The advertisement is displayed at the top of the website. The advertisement may be inserted into a right advertisement spot 430, where the advertisement is displayed on the right side of the website. In some cases the advertisement is inserted into a seamless lay advertisement spot 440, which is attached to the image. For example, the advertisement appears as a header of the image. In some exemplary embodiments of the subject matter, the advertisement may be embedded onto the image 410. The advertisement is hidden and is displayed upon detection of a mouse hover over the image 410. FIG. 5 shows an interface to choose a type of user that inserts an advertisement according to an image on a website, according to some exemplary embodiments of the subject matter. The interface 500 comprises an affiliate display 510, which is a window through which an affiliate of a website may enter and match tags with advertisements. The affiliate display 510 may comprise an affiliate icon 515, which enables accessing an interface for connecting tags to an image, such as that of FIG. 3. In some exemplary embodiments of the subject matter, the user is an advertiser, who wants to have an advertisement displayed on the website. The interface 500 comprises a merchant display 530 to enable the advertiser to match advertisements to images. The merchant display 530 comprises a merchant icon 535, which enables the merchant to access the interface for connecting tags to an image, such as that of FIG. 3. The advertiser may attach an advertiser's advertisement to the image on the website. The advertiser then may bid to have the advertiser's advertisement displayed on the website or as a lay seamless on the image.

FIG. 6 shows a computerized environment for embedding an advertisement into an advertisement spot on a website, according to some exemplary embodiments of the subject matter. The computerized environment 600 comprises a server 610, which communicates with a computerized viewer device 620, a computerized website administrator device 630, a computerized advertiser device 640, or a combination thereof The computerized viewer device 620, the computerized website administrator device 630, the computerized advertiser device 640 may include computerized devices as use of the terms ‘processor’, ‘computer’ in the art as disclosed herein. The viewer device 620 is configured to enable a viewer to access a website. The website comprises content made viewable to the viewer via the viewer device 620. The viewer device 620 may represent multiple computerized devices used to view the website and the content displayed therein. The viewer device 620 may include, or may be associated with a viewer user interface enabling a viewer to view and interact with the website and content displayed in the website, e.g. an advertisement. For example, the viewer interface may be an application which is installed on the viewer device 620 or accessed from it.

The website displays advertisements in predetermined advertisement spots. Advertisements are displayed in advertisement spots on the website. The advertisements are selected and embedded by the server 610 according to the methods described herein in FIGS. 8-10. The website administrator device 630 is configured to manage and administrate content displayed on the website.

The website administrator device 630 provides the server 610 with the website content from which image tags are generated. The image tags comprise terms that describe or characterize the at least one image displayed on the website. The image tags enable the server 610 to select preferred advertisement to be displayed in the advertisement spot. The image tags are associated with at least one image displayed on the website.

In some cases, the web administrator device 630 is configured to provide a dedicated administrator graphic user interface to input the image tags for selecting the advertisement to be displayed in the advertisement spot, e.g. by a web administrator The advertiser device 640 is configured to provide the server 610 the advertisement and/or advertisement campaign, which an advertiser wishes to have displayed in the advertisement spot. The advertiser device 640 is configured to provide or display a graphic user interface, which is configured to receive advertisement input data from the advertiser device 640. The advertisement input data comprises the advertisement and/or advertisement campaign, an advertisement tag, a tag bid value associated with the advertisement tag and/or with the advertisement, or the like. In some embodiments, the advertisement may include a web hyperlink, or a suggested article with similar content, or a link to a suggested application installation, etc. The advertisement tags comprise textual terms the advertiser uses to describe the advertisement and/or advertisement campaign.

The server 610 comprises a tag processor 612, which computes scores or ranks advertisements in order to select a best-fitting advertisement, and embed it into an advertisement spot associated with an image and/or content displayed on a website according to the computed scores.

The server 610 selects a most relevant advertisement selected according to a calculation of an advertisement score determined based on a plurality of predetermined criteria. The advertisement score enables selecting the advertisement that is most likely to appeal to viewers of the website and which is most likely to be clicked on by the viewer.

The calculation of the advertisement score and selection of the advertisement according to it is further described herein in FIGS. 8-10. The tag processor 612 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

The server 610 comprises a website data storage 614 configured to store data related to the website in which advertisements are embedded. The website data storage 614 stores image, image-related data and image tags associated with images displayed on a website. Image tags identify and characterize an image, objects in the image, or the like. In some cases, the website data storage 614 stores metadata related to the image, for example, the title of the image, the description of the image, or the like. The metadata is used to generate image tags. In some exemplary embodiments of the subject matter, the image tags are stored separately, e.g. storing image tags generated from metadata as metadata image tags and storing image tags generated from image recognition as image-recognition image tags.

The server 610 comprises an advertisement storage 616 configured to store advertisements, e.g. images or video clips or other visual data for display, and advertisement campaign data. For example, storing the advertisement tags, tag bid values associated with the advertisement tags, a click rate for the advertisement tags, a bid score, impression value, or the like.

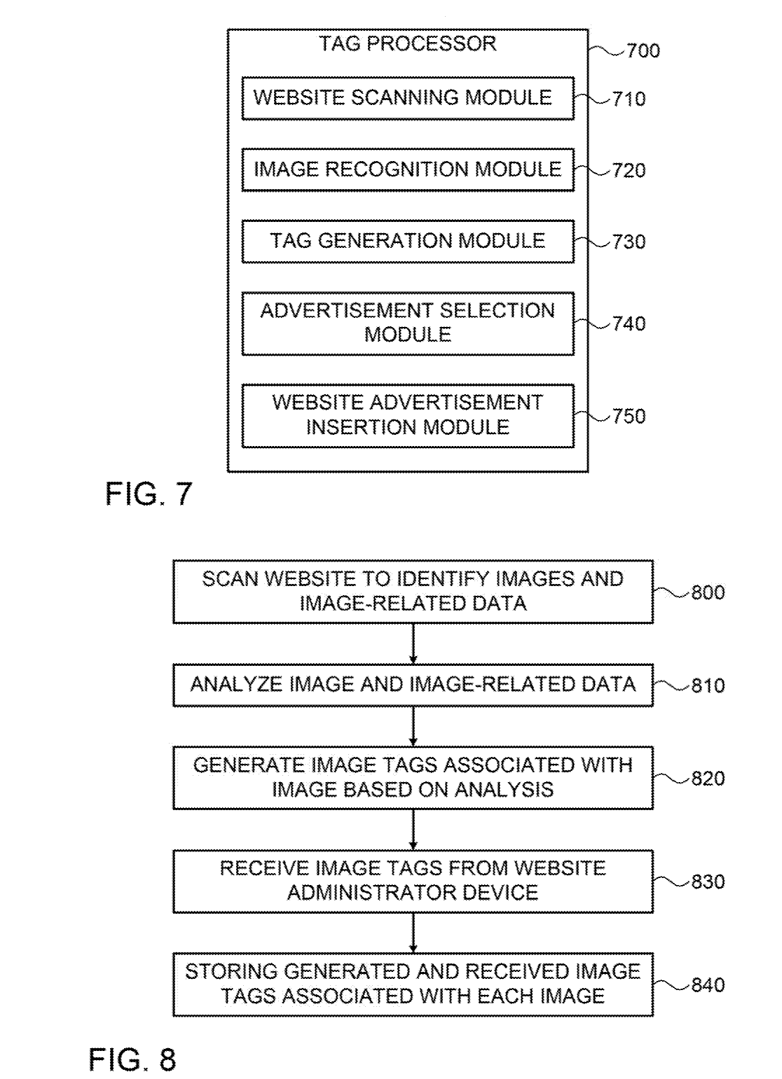

FIG. 7 shows a tag processor, according to some exemplary embodiments of the subject matter. The tag processor 700 comprises a website scanning module 710 configured to scan a website to identify images and image-related data. For example, the website scanning module 710 identifies meta-data, http code or the like, to identify images and image-related data on the website.

In some exemplary embodiments of the subject matter, the website administrator device 630 of FIG. 1 embeds computer executable code into the website code to enable the tag processor 700 access to the scan the website to identify and generate image tags from images on the website. For example, the website administrator may embed a portion of code or software instructions into a website's code or software, which is recognized by the tag processor 700 and causes initiation of the scanning module 710 to scan the website to for images and to locate the advertisement spots in the website.

The website scanning module 710 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

The tag processor 700 comprises an image recognition module 720 configured to recognize characteristics of an image. The image recognition module 720 analyzes image and its characteristics to generate related image tags. The image recognition module 720 identifies characteristics that describe the image according to the image and image related data. The image related data may comprise metadata of the image. The identified characteristics enable generating the image tags. In some cases, the characteristics describe objects displayed in the image.

The image recognition module 720 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

The tag processor 700 comprises a tag generation module 730 configured to generate image tags according to characteristics identified by the image recognition module 720. The tag generation module 730 recognizes objects in the image via image recognition, which are used to generate the image tags. For example, recognizing objects such as basketballs, soccer-balls, etc. to generate image tags for “basketball”, “sports”, “balls”, “soccer”, or the like. The tag generation module 730 generates image tags from data provided in the metadata, for example, an image title, an image description, an image filename, or the like. The tag generation module 730 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

In some exemplary embodiments of the subject matter, the generated image tags are arranged in a certain image tag order, which indicates the level of importance or a rank of the image tags, according to the accuracy or correlation between the image tags and the image. The correlation between each image tag and the image may be determined according to predetermined criteria that are customizable by the website administrator.

The tag processor 700 comprises an advertisement selection module 740 configured to embed the advertisement into an advertisement spot in the website. The advertisement selection module 740 selects the advertisement according to the method disclosed below in FIGS. 8-10. The advertisement selection module 740 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein.

The tag processor 700 comprises an advertisement insertion module 750, which selects the advertisement to embed into the advertisement spot. Once the advertisement selection module 740 selects the advertisement according to the predetermined criteria as further disclosed in FIGS. 8-10, the advertisement insertion module 750 embeds the selected advertisement in to the advertisement spot designated in the website. The advertisement insertion module 750 may include or may be operationally connected to, an article, such as a non-transitory computerized system or processor-readable storage medium, e.g. a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

FIG. 8 shows a method for obtaining image identification tags from a website, according to some exemplary embodiments of the subject matter. Step 800 discloses scanning textual data and image data provided in a website to identify images and image-related data.

The identification of the images may be performed using automatic image recognition or image analysis, to recognize characteristics of the image, e.g. objects in the image, colors, textures, or the like. The image-related data identified may include meta-data, image text, image title, or the like. The metadata of the image is scanned for generating image tags.

Step 810 discloses analyzing the image and the image-related data. The images and the image related data are analyzed to locate and identify objects in the image. The objects may be identified using an image recognition application, such as via a computer executable application programming interfaces (API) such as Camfind, Vufind recognize, Catchoom, or the like. In some exemplary embodiments the analysis includes identifying characteristics of the image using metadata associated with the image, for example data provided in the title of the image, in description field related to the image, etc. The metadata of the image is analyzed, for example, to determine identifying terms that are used to describe the image in the metadata, such as the image title, the image description, or the like.

Step 820 discloses generating image tags associated with the image and the image-related data based on the analysis. The image tags are generated comprising one or more terms that were determined in operation 810 as describing or related to or characterizing objects identified in the image. For example, in an image of a soccer game, the generated image tags may include terms such as: soccer, sports, or the like, which characterize what is displayed in the image.

In some exemplary embodiments of the subject matter, the server 610 of FIG. 1 differentiates between image tags generated from an image recognition and image analysis module, and image tags generated from metadata related to the image. Differentiating between the different types of image tags generated enables designating a certain priority, a score or a level of preference to image tags generated from metadata. For example, a higher score may be generated or provided to image tags generated based on metadata related to the image, when matching image tags with advertisement tags in order to select the advertisement. In some exemplary embodiments, the designation characterizes the image tags as metadata image tags, which are generated from the image, image-related data, metadata, or the like, and image recognition image tags, which are generated from the image recognition performed during the analysis of the image.

Step 830 discloses receiving image tags from the website administrator device 630 of FIG. 6. In some cases, the website administrator device 630 provides the image tags to the server 610. For example, the website administrator inputs terms to be used as image tags into the website administrator device 630, through a dedicated administrator application or web administrator user interface. The dedicated administrator application or web administrator graphic user interface communicates the inputted image tags to the server 610 to provide the received image tags. The received terms may be generated as image tags and transmitted by the application or dedicated user interface to the server 610. It should be noted that this step is optional and is not required for completion of the process.

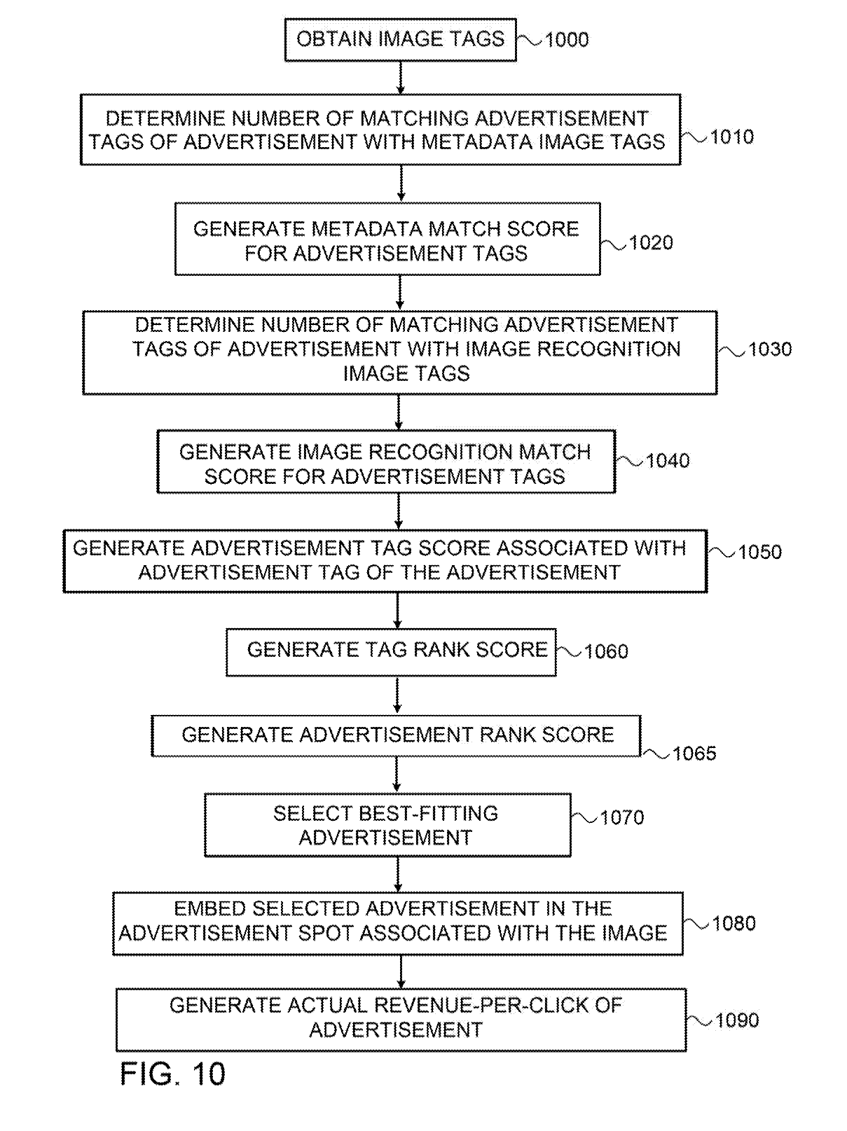

Step 840 discloses storing the generated and received image tags associated with each image. The image tags are stored in the website data storage 614 of FIG. 6. The image tags are stored with the image and image-related data to which the image tags are associated. In some exemplary embodiments of the subject matter, the image tags are organized in a certain image tag order, according to the accuracy of the image tag for describing the image with which the image tags are associated, or according to the level of importance of each tag associated with an image. In some exemplary embodiments of the subject matter, image tags generated from metadata and/or from image-related data, e.g. metadata image tags, are stored separately from image tags generated from image recognition, e.g. image recognition image tags. Storing the image tags separately, e.g. as metadata image tags and as image recognition image tags, enables applying different scoring scheme to the matched advertisement tags as disclosed herein in FIG. 10, on the basis of the origin of the image tag.

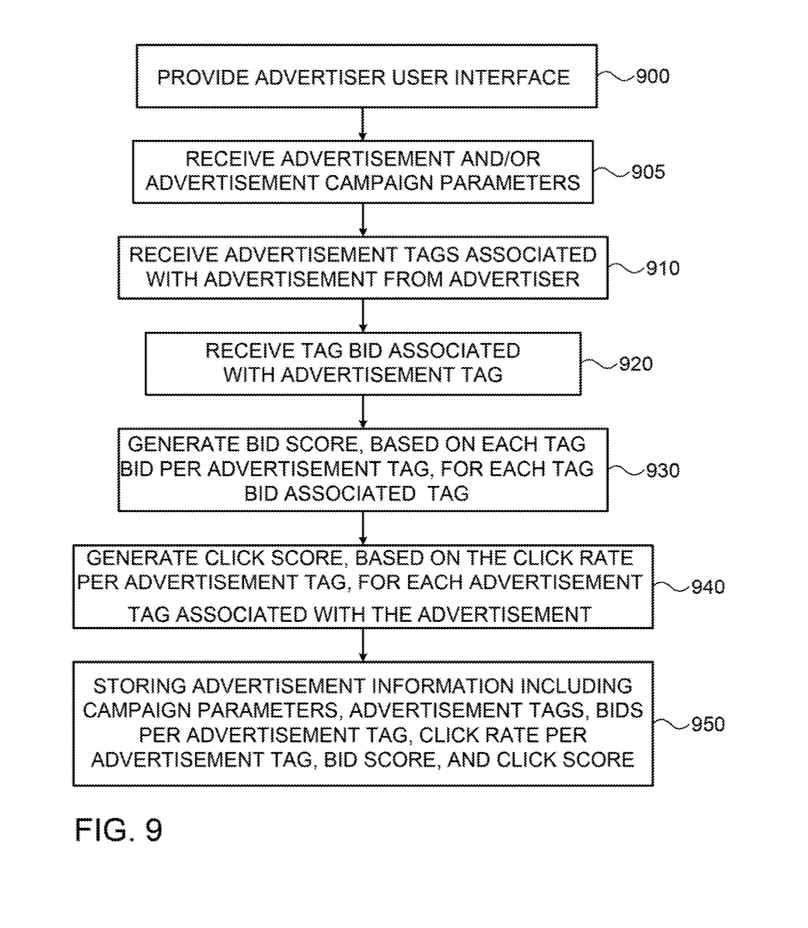

FIG. 9 is a flow chart of a method for obtaining advertisement data, according to some exemplary embodiments of the subject matter. Step 900 discloses providing an advertiser user interface. In some embodiments, the server 610 of FIG. 6 may provide the advertisement user interface for obtaining advertisements. In other embodiments, an application with the advertiser user interface may be installed on the advertiser's device. The advertisement user interface is accessible via the advertiser device 640 of FIG. 6. The advertiser user interface enables an advertiser to provide an advertisement, an advertisement tag, a tag bid value associated with the advertisement and/or the advertisement tag, or the like to the server 610 via the advertiser device 640. In some exemplary embodiments of the subject matter, the advertiser user interface is accessed and associated with the advertiser device 640 via a dedicated application.

Step 905 discloses receiving an advertisement (e.g. an image or a data file to be displayed in an advertising spot) and/or an advertisement campaign data. The server 610 receives the advertisement and/or advertisement campaign data from the advertiser device 640. An advertiser inputs a selected advertisement and/or advertisement campaign into an advertiser user interface provided via the advertiser device 640, which is configured to provide the user interface for obtaining the advertisements from the user. The advertisement is an advertisement that the advertiser wishes to have displayed on an advertisement spot. The advertiser device 640 then transmits the advertisement and/or advertisement campaign data to the server 610. The advertisement and/or advertisement campaign may be an interactive object, e.g. an image, a gif, or the like, which provides a hyperlink (URL) to the advertiser's website for purchasing the advertiser's products and/or services. In some cases, the advertisement and/or advertisement campaign is of a predetermined range of a file size so it may fit into the advertisement spot on the website, for example, the advertisement is between 400-600 kilobytes in a certain file format, e.g. GIF file.

Step 910 discloses receiving an advertisement tag associated with the advertisement from an advertiser user interface provided by an advertiser device 640. The advertiser device 640 provides the advertisement tags to the server 610. The advertisement tags comprise textual terms that describe and characterize the advertisement and/or advertisement campaign. For example, for an advertisement for soda beverages, the advertiser inputs advertisement tags with terms such as “beverage”, “soda”, “refreshment”, “pop”, etc.

Step 920 discloses receiving a tag bid value associated with an advertisement tag of the advertisement. The server 610 receives the tag bid values that are associated with the advertisement tags from the advertiser device 640. The tag bid value is inputted into the advertiser device 640 by the advertiser. The tag bid is inputted via the advertiser user interface. The tag bid values are transmitted via the advertiser device 640 to the server 610. Each tag bid value is a maximum monetary value that the advertiser is willing to pay to have the advertisement displayed in an advertisement spot. The tag bid value is provided for each advertisement tag, and is inputted via the advertiser user interface, for example, on the advertiser prompt, e.g. the bid box 370 of FIG. 3. The advertiser user interface is displayed on the advertiser device 640, which provides a convenient interface for the advertiser to input the tag bid values for the advertisement tags. In some cases, the advertiser device 640 may be configured to associate all advertisement tags of a specific advertisement with the same valued tag bid value. In these cases, a single tag bid value is provided for an advertisement, and then automatically associated with all of the advertisement tags associated. Optionally, a single advertisement bid may be provided and associated with all tags of an advertisement. The advertiser deposits the tag bid value amount as payment, for example by providing payment via credit card, bit coin, or the like.

Step 930 discloses generating a bid score, based on each tag bid value per advertisement tag. Each advertisement tag received and stored in the server 610 is associated with a tag bid value. The server 610 is configured to associate a value to each tag bid value, and to generate a bid score for each tag bid value. For example, a scaled value, such as a score within a predetermined range (e.g. from 1-10) may be associated with each tag bid value, which may be assigned to a bid value according to the value of the tag bid relative to the value of the other tag bids received by the server 610. For example, the server 610 may receive bids with values $100, $60, $10, and $0. For a scaling factor of 0.1, the tag bids may be assigned bid scores of 10, 6, 1, and 0 respectively according to one exemplary scaling factor presented herein. Other weights or scaling factors may be used.

Step 940 discloses generating a click score, based on a click through rate (CTR). In some non-limiting embodiments, an advertisement has been previously displayed in one or more websites. The CTR is a calculated value according to a number of times an advertisement was clicked when displayed in one or more websites. For example, the CTR is a ratio of the number of times the advertisement was clicked on by a viewer of a website (also referred to as a click rate), and the number of times the advertisement was displayed on the website (also referred to as an impression value). The CTR is determined for the advertisement and used to generate the click score for the advertisement tags. In some cases, the click rate is a cumulative value of the number of times an advertisement was clicked. The cumulative value is stored and continuously updated by the server 610.

The server 610 generates a click score for each advertisement tag according to the CTR of the advertisement. For example, the click score is a scaled value which may be within a predetermined range of values, similar to the bid score. In some cases, where the advertisement is a new advertisement, the server 610 provides the advertisement with an initial click score value, which may be higher than a minimum click score value, to not harm the advertisement's final score and to enable new advertisements to be selected to be displayed. The initial click score may be a predetermined number or score, or may be calculated, for example, based on average click scores of advertisements that include the same or similar advertisement tags.

Step 950 discloses storing advertisement information including campaign parameters, advertisement tags, and bids per advertisement tag, click rate per advertisement tag, bid score, and click score. The server 610 stores the advertisement information in the advertisement storage 618.

FIG. 10 shows a method for associating an advertisement to an image, according to some exemplary embodiments of the subject matter. Step 1000 discloses obtaining image tags. The server 610 of FIG. 6 obtains the image tags from the website storage 614 of FIG. 6 in real time. The image tags are used to select the advertisement to be embedded into the advertisement spot. For example, the image tags are obtained by the server 610 of FIG. 6 each time the website is uploaded by a user via the user device 620 of FIG. 6. The server 610 obtains the image tags to provide the user with relevant advertising in real time according to the image tags associated with images on the website the user is accessing. The image tags may include metadata image tags and image recognition image tags.

Step 1010 discloses determining a number of matching advertisement tags of the advertisement with metadata image tags. The advertisement tags and the metadata image tags comprise terms that describe the advertisement and the image respectively. The server 610 matches the advertisement tags and the metadata image tags according to the terms presented in the advertisement tags and the metadata image tags.

Step 1020 discloses generating a metadata match score for the advertisement tags according to a predetermined calculation. The server 610 generates the metadata match score for each advertisement tag according to the number of advertisement tags that are matched to metadata image tags per advertisement. For example, where a first advertisement is associated with advertisement tags A, B, C, a second advertisement is associated with advertisement tags A, B, D, E and an image is associated with metadata image tags A, B, C. The first advertisement will have a three advertisement tags match with the metadata image tags, while the second advertisement has two advertisement tags match. Each advertisement tag of the first advertisement will each receive a maximum score, e.g., on a predetermined scale or range of values, for example, of 10 on a scale of 1-10. The advertisement tags A and B of the second advertisement will receive an intermediate score, e.g. a score of 5 and the advertisement tags D and E of the second advertisement will receive a minimum score, e.g., of 1. It should be noted that the metadata match score may be calculated differently based on the number of metadata image tags that were determined to be matching with the advertisement tags. A “match” or “matching” when referred to herein, may include, determining identical or similar terminology, words, phrases, or the like, used in image tags and advertisement tags.

Step 1030 discloses determining a number of advertisement tags of the advertisement matching with image recognition image tags. The advertisement tags and the image recognition image tags comprise terms that describe the advertisement and the image respectively. The server 610 matches the advertisement tags and the image recognition image tags according to the terms, phrases, words, or the like, presented in the advertisement tags and the image recognition image tags.

Step 1040 discloses generating an image recognition match score for the advertisement tags according to a predetermined calculation. The server 610 generates the image recognition match score for each advertisement tag according to the number of advertisement tags that are matched per advertisement. For example, a first advertisement may be associated with advertisement tags X, Y, Z, and a second advertisement may be associated with advertisement tags U, V, Y, Z and an image may be associated with image recognition image tags X, Y, Z. The first advertisement will have a three advertisement tags match with the image recognition image tags, while the second advertisement has two advertisement tags matching the image recognition image tags. The advertisement tags of the first advertisement tag will each receive a maximum score, e.g., on a predetermined scale or range of values, for example, of 10 on a scale of 1-10. While the advertisement tags Y and Z of the second advertisement will receive an intermediate score, e.g. a score of 5 and the advertisement tags U and V of the second advertisement will receive a minimum score, e.g. a score of 1. It should be noted that the image recognition match score may be calculated differently based on the number of image recognition image tags that were determined to be matching with the advertisement tags.

In some exemplary embodiments of the subject matter, the calculation of the image recognition match score may further be based on an image recognition confidence value, which indicates a level of confidence, which was received from the image recognition module 720 of FIG. 7. The confidence value may be a score from a predetermined range of value, e.g. a predetermined range of 1-10.

The image recognition match score may be calculated by determining a total number of matching image recognition image tags and advertisement tags between the image on the website and the advertisement and the confidence value, where each parameter may be associated with a predetermined weight or ration.

Step 1050 discloses generating an advertisement tag score associated with each advertisement tag of the advertisement. The advertisement tag score is generated according a predetermined calculation based on the scores associated with each advertisement tag, e.g. metadata match scores, the image recognition match scores, the bid scores, and the click scores.

In one embodiment, one or more predetermined weights or ratio values may be used to calculate the advertisement tag score. For example, a bid score may receive a first predetermined weight, a click score may receive a second predetermined weight, a metadata match score may receive a third predetermined weight, and the image recognition match score may receive a fourth predetermined weight. The combination of the predetermined weight values and the scores associated with each advertisement tag are used to obtain the advertisement tag score.

Step 1060 discloses generating a tag rank score for an advertisement. The tag rank score is generated based on one or more of the following parameters: the advertisement tag score of each advertisement tag and the tag bid value of the advertisement tag. The tag rank score may be calculated for example by calculating a product of the advertisement tag score and the corresponding tag bid associated with the same advertisement tag. For example, a first advertisement tag score has a value of 10 and the associated bid value of $2, the advertisement rank score for the advertisement tag will be 20.

Step 1065 discloses generating an advertisement rank score according to the tag rank scores associated with an advertisement. For example, the maximum tag rank score may be assigned as the advertisement rank score. In other non-limiting embodiments, other manners of calculation may be used to generate the advertisement rank score.

Step 1070 discloses selecting a best-fitting advertisement, e.g. the advertisement which will be most effective or have the highest chance of being clicked by the website viewer, according to the advertisement rank score of the advertisement. According to the advertisement rank score of the advertisements stored in the advertisement storage 616 of FIG. 6, the server 610 selects the best-fitting advertisement, which is, for example, the advertisement with a highest advertisement rank score provided according to step 1065, to be embedded into the advertisement spot. In some cases, the selection is performed by the advertisement selection module 740 of FIG. 7. In some exemplary embodiments of the subject matter, the advertisements are ranked according to the advertisement rank scores, and several advertisements are selected to be embedded into several advertisement spots in the website. The advertisement spots are provided to the server 610 with a priority of which advertisement spots are the most effective. The several advertisements are embedded into the advertisement spots according to the advertisement scores. For example, the advertisement with the highest advertisement score is embedded into the advertisement spot with the highest priority and the advertisement with the second highest advertisement score is placed in the advertisement spot with the second priority. It should be noted, that advertisement tags associated with the same advertisement may have “competing” advertisement rank scores for the same advertisement spot, while at the same time competing with advertisement tags associated with other advertisements.

Step 1080 discloses embedding the selected advertisement in an advertisement spot associated with the image. The server 610 embeds the advertisement selected into the advertisement spot, which enables the advertisement to be displayed in the website when viewed by a viewer via the viewer device 620 of FIG. 6. In some cases, the advertisement is embedded into the advertisement spot via the advertisement insertion module 750 of FIG. 7.

Step 1090 discloses generating a revenue-per-click for the advertisement. The value of the revenue-per-click is determined according to one or more of the following parameters: an advertisement tag score, an advertisement rank score, a tag rank score and a predetermined monetary value, or a combination thereof. In some exemplary embodiments, the advertiser whose advertisement is selected to be embedded will not pay an amount greater than an associated bid value, or lower than a predetermined minimal amount.

In one non-limiting embodiment, the revenue-per-click is determined for a first advertisement tag, which was used to select the advertisement that was embedded in the advertisement spot, according to an advertisement tag score of the first advertisement tag and a tag rank score of a second advertisement tag, which had a lower advertisement rank score than the first advertisement. The advertisement tag score and advertisement rank score are calculated with a predetermined monetary value, which generates the revenue-per-click for the advertisement.

Once the advertisement is displayed on the website, each time a viewer clicks on the advertisement, the server 610 of FIG. 6 provides the website administrator with revenue, according to the value of the actual revenue-per-click. For example, when the advertisement is clicked, the revenue generated from the click is transferred to the account of the website administrator.

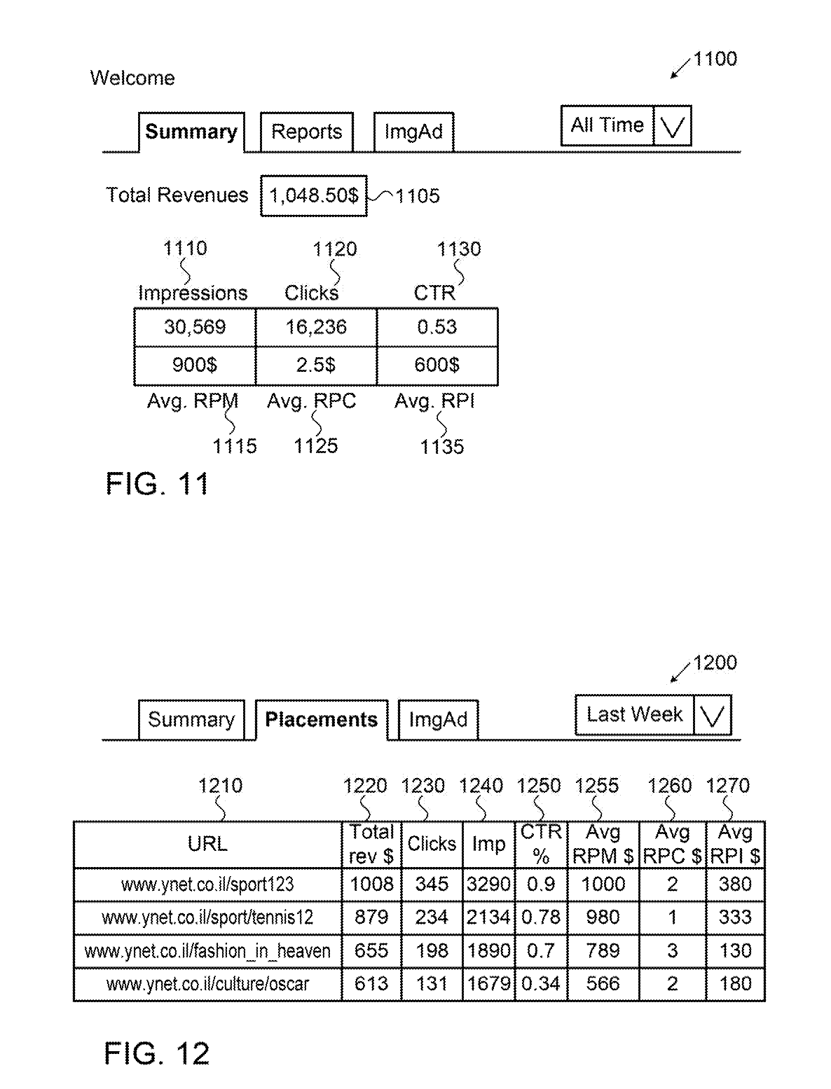

FIG. 11 shows a schematic website administrator user interface displaying a summarized display of information related to advertisements selected for display on the website, according to some exemplary embodiments of the subject matter. The summary page 1100 displays for the advertiser a summary of information related to the advertisements the advertiser is providing to be presented in advertisement spots. For example, the summary page 1100 displays a total revenue value 1105, an impressions value 1110, clicks value 1120 (e.g. a total number of times viewers clicked the advertisements), and click-through rate (CTR) 1130.

The total revenue 1105 is the total amount of payment the website owner receives from displaying advertisements on the website. Each time an advertisement is displayed by the server 610, the website owner receives a payment, which is a predetermined portion of the bid the advertiser offered to pay to have the advertisement displayed. The revenues received from each displayed advertisement are summed by the server 610 to provide the total revenue value. The impressions 1110 is the total times advertisements are displayed on the website. The clicks is a total number of times the advertisements are clicked when displayed on the website. The CTR value 1130 is the ratio of the clicks value 1120 per impressions value 1110.

The summary page 1100 displays an average revenue-per-mill 1115, which is the revenue received by the website administrator for displaying of one thousand advertisements. The summary page 1100 displays an average revenue-per-click (RPC) 1125, which is the amount of revenue the website administrator obtains each time an advertisement displayed on the website is clicked. The average RPC 1125 is calculated by the server 610 according to the bids of the advertisements displayed and the clicks 1120. The summary page 1100 displays a revenue-per-image 1135, which is an average revenue obtained according to the association of the image with advertisements, e.g. to enable a publisher to know if the images displayed on the website associate with profitable advertisements.

FIG. 12 shows a schematic website administrator user interface displaying information related to advertisement spots comprising advertisement placements, according to some exemplary embodiments of the subject matter. The placement page 1200 displays for the website administrator a list of pages of the website in which advertisements are being displayed. In some cases, the placement information may be displayed in a table comprising, for example, a URL column 1210 of the webpage in which the selected advertisement was displayed. The table may include a total revenue column 1220, which is the total revenue obtained based on advertisements displayed on the page of the website. The total revenue is the sum of revenue obtained when the advertisements are clicked by the webpage surfer, on the page of the website. The table displays a number of clicks column 1230, which indicates the number of times the advertisements are clicked when displayed on the page. The table displays a total impression column1240, which shows the total number of times advertisements are displayed on the page. The table displays a CTR column 1250, which is the ratio of the clicks per impressions. The table displays an average revenue-per-mill column 1255, average revenue-per-click column 1260, and average revenue-per-impression column 1270.

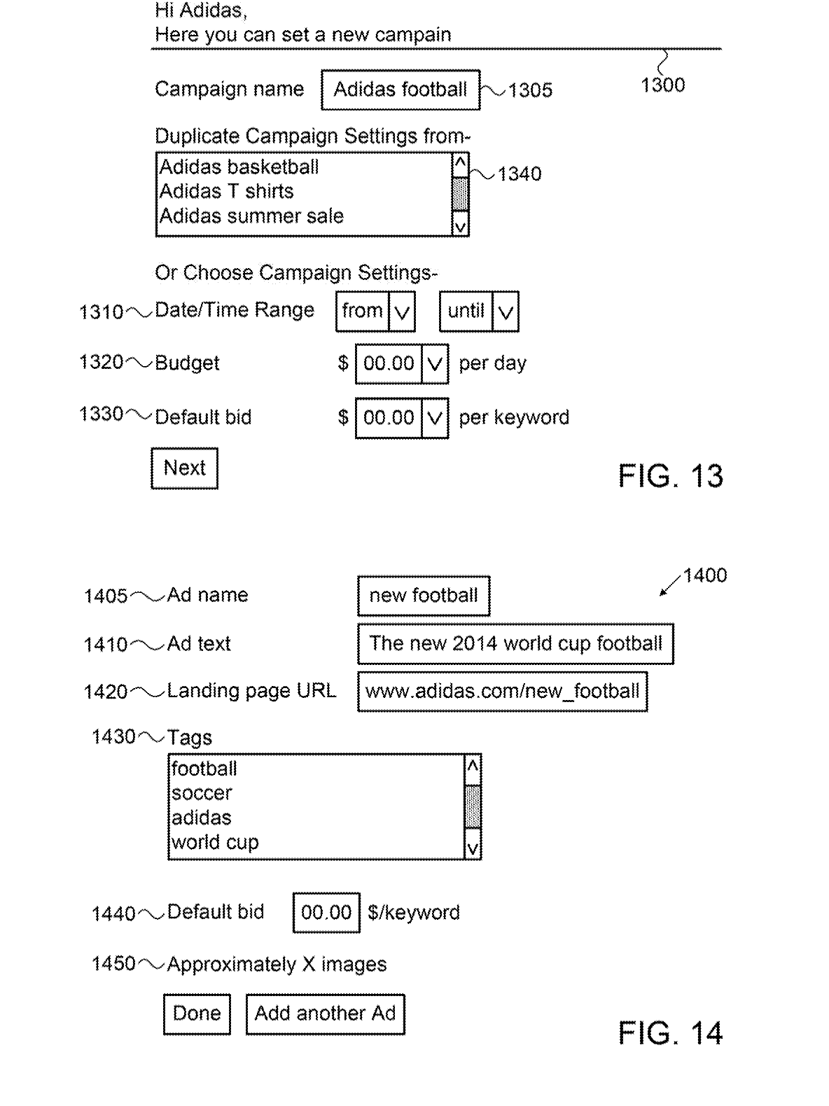

FIG. 13 shows a schematic of an advertiser user interface displaying an advertisement campaign adding interface, according to some exemplary embodiments of the subject matter. The advertisement campaign adding interface 1300 comprises an interface to insert information regarding a new advertisement campaign. For example, the advertisement campaign adding interface 1300 comprises a campaign name insert box 1305, date range 1310 for inserting a time during which the advertisement is to be displayed, a budget 1320 (e.g. bids), a default bid 1330 or the like. In some cases, the advertisement campaign adding interface 1300 may comprise a duplicate campaign option 1340, which enables the advertiser to select using previous advertisement settings for the new advertisement, e.g. the date range, the budget, or the like.

FIG. 14 shows a schematic of an advertiser user interface displaying a new advertisement campaign addition interface, according to some exemplary embodiments of the subject matter. The new advertisement campaign addition interface 1400 comprises an interface to insert information such as an ad name 1405, ad text 1410 (e.g. a description of the advertisement), advertisement URL 1420, advertisement tags 1430, bid value 1440, or the like. In some cases, the advertisement URL may be a link to an application installation, content recommendation media (a pop up providing recommended content), a link to a suggested application installation file, or the like. The bid 1440 may be inserted per advertisement tag and/or per advertisement, e.g. the bid entered is associated with all of the bids of the advertisement. In some non-limiting embodiments, the new advertisement campaign addition interface 1400 comprises a banner insertion option, which provides the advertiser with the option to upload a banner, e.g. an image, gif, video, or the like with/or as an alternative to the advertisement URL 1420.

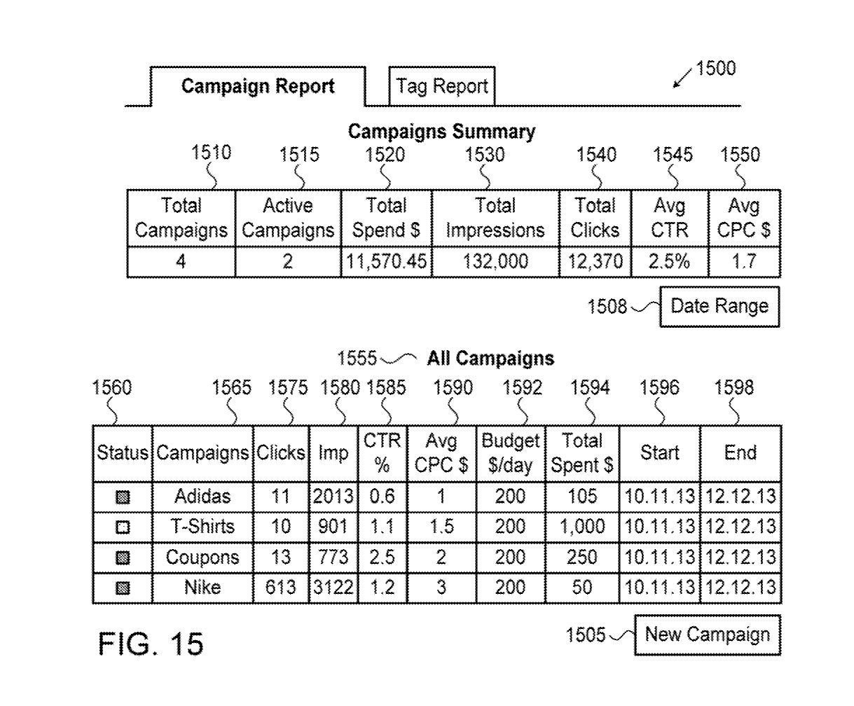

FIG. 15 shows a schematic of an advertiser user interface displaying a first embodiment of an advertisement summary campaign report display for an advertiser, according to some exemplary embodiments of the subject matter. The advertisement summary campaign report display 1500 is provided by the server 610 of FIG. 6 to display a summary of the profits and success of a specific advertisement. The advertisement summary campaign report display 1500 is provided by the server 610 and is accessible via the advertiser device 630 of FIG. 6 to be displayed, for example, through an advertiser user interface display. For example, the advertisement summary campaign report display 1500 may display a total number of advertisements 1510, a number of active advertisements 1515, a total amount of money spent on the advertisements 1520, total number of impressions 1530, total number of clicks 1540, average click-through-rate 1545, average money per click 1550, or the like. The advertisement summary campaign report display 1500 may display a date range 1508, which displays the dates of activity of the advertisements. The advertisement summary campaign report display 1500 may display the total advertisements, for example via a table 1555, which includes columns displaying status of the advertisement 1560, name of advertisement 1565, number of clicks 1575, total number of impressions 1580, click-through-rate 1585, average sum per click (CPC) 1590, budget, e.g. bids 1592, total funds spent by advertiser to date 1594, date advertisement started being displayed 1596, date advertisement stopped being displayed 1585, or the like. The advertisement summary campaign report display 1500 may provide an interface for entering a new advertisement campaign 1505. In some non-limiting embodiments, the advertisement summary campaign report display 1500 comprises a chart and/or table, which displays a summary of the advertisement and/or advertisement campaign information, such as the status of the advertisement 1560, name of advertisement 1565, number of clicks 1575, total number of impressions 1580, click-through-rate 1585, average sum per click (CPC) 1590, budget, e.g. bids 1592, total amount spent by advertiser 1594, date advertisement started being displayed 1596, date advertisement stopped being displayed 1585, or the like.

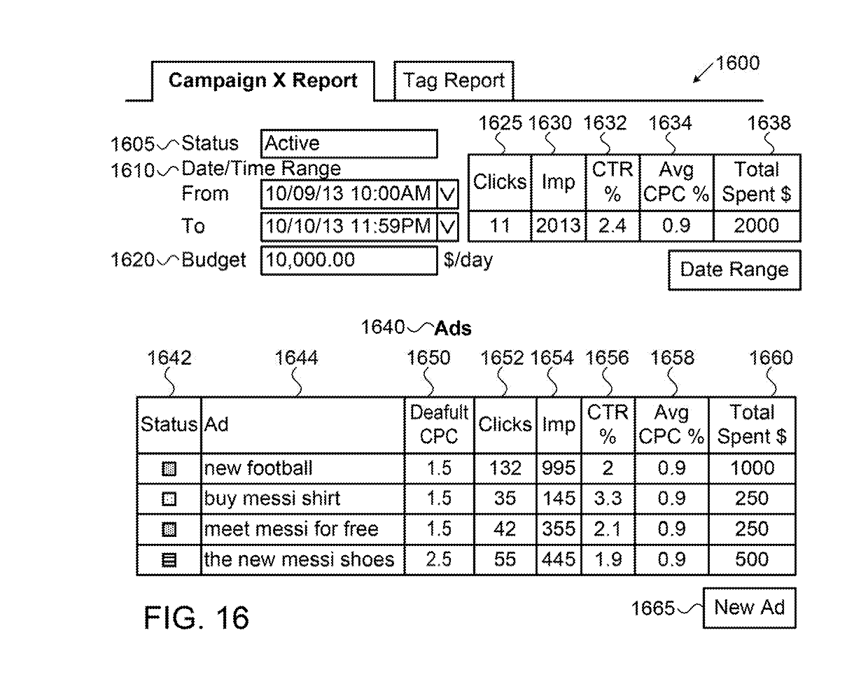

FIG. 16 shows a schematic of an advertiser user interface displaying an advertisement campaign report, according to some exemplary embodiments of the subject matter. The second embodiment of an advertisement campaign report 1600 may display a status 1605 of the advertisement, an activity date range 1610 of the advertisement, a budget 1620 (e.g. bids), clicks of a particular campaign 1625, impressions 1630, CTR 1632, average CPC 1634, total amount spent on the advertisements 1638, or the like. The second embodiment of the advertisement summary campaign report display 1600 may display the total advertisements, for example via a table 1640, which includes columns displaying status of the advertisement 1642, name of advertisement 1644, default CPC 1650, number of clicks 1652, total number of impressions 1654, click-through-rate 1656, average sum per click (CPC) 1658, budget, e.g. bids 1592, total amount spent by advertiser 1660, or the like. The second embodiment of the advertisement summary campaign report display 1600 may provide an interface for entering a new advertisement campaign 1665.

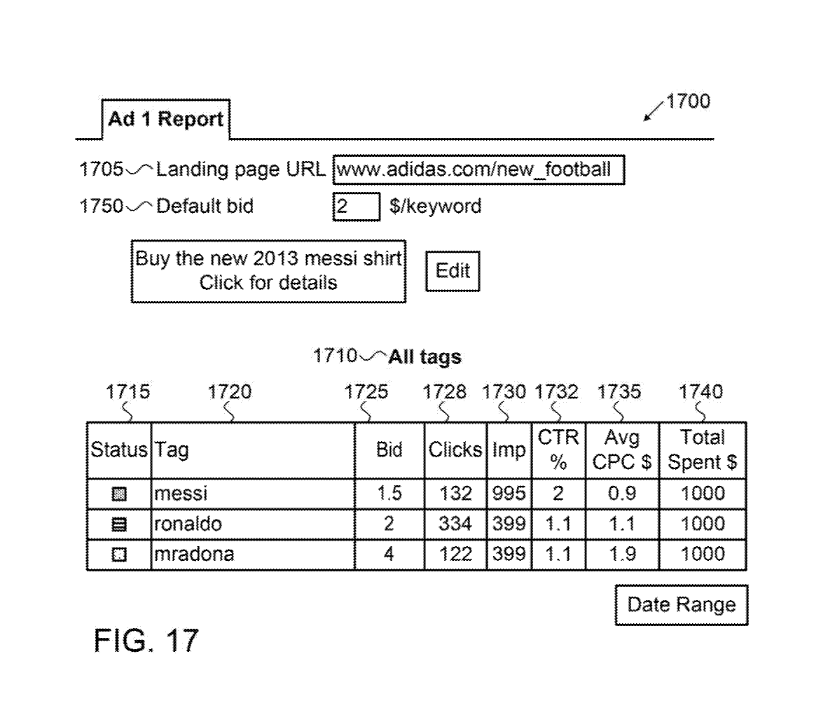

FIG. 17 shows a schematic of an advertiser user interface displaying an advertisement report display, according to some exemplary embodiments of the subject matter. The advertisement report display 1700 may display an advertisement URL 4705, a bid value 1750 (e.g. a bid per advertisement tag), a sample display of the advertisement 1708, an advertisement tag table 1710, or the like. The advertisement tag table 1710 displays information related to the advertisement tags associated with the advertisement. For example, the advertisement tag table 1710 displays an advertisement tag status 1715, an advertisement tag title 1720, an advertisement tag bid 1725, an advertisement tag click number 1728, an advertisement tag impression time 1730, an advertisement tag CTR 1732, an advertisement tag average CPC 1735, total money spent 1740 on the advertisement tag, or the like.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports.

Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

As used herein the term “configuring” and/or ‘adapting’ for an objective, or a variation thereof, implies using materials and/or components in a manner designed for and/or implemented and/or operable or operative to achieve the objective.

Unless otherwise specified, the terms ‘about’ and/or ‘close’ with respect to a magnitude or a numerical value implies within an inclusive range of −10% to +10% of the respective magnitude or value.

Unless otherwise specified, the terms ‘about’ and/or ‘close’ with respect to a dimension or extent, such as length, implies within an inclusive range of −10% to +10% of the respective dimension or extent.

Unless otherwise specified, the terms ‘about’ or ‘close’ imply at or in a region of, or close to a location or a part of an object relative to other parts or regions of the object.

When a range of values is recited, it is merely for convenience or brevity and includes all the possible sub-ranges as well as individual numerical values within and about the boundary of that range. Any numeric value, unless otherwise specified, includes also practical close values enabling an embodiment or a method, and integral values do not exclude fractional values. A sub-range values and practical close values should be considered as specifically disclosed values.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

Terms in the claims that follow should be interpreted, without limiting, as characterized or described in the specification.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A computer-implemented method for selecting and displaying advertisements on a website, the method comprising:
scanning, by a server, a website to obtain an image and image metadata embedded in the website;
analyzing, by the server, the image and the image metadata to locate characteristics identifying the image;
generating, via the server, one or more image recognition image tags associated with the image, wherein the one or more image tags are generated according to an image recognition performed during the analysis of the image;
generating, via the server, one or more metadata image tags associated with the image, wherein the one or more image tags are generated according to the analysis of metadata related to the image;
providing, via the server, an advertiser user interface displayed on an advertiser device for obtaining an advertisement, at least one associated advertisement tag, and a tag bid value associated with the advertisement tag;
receiving, at the server, the obtained advertisement from the advertiser device;
generating, via the server, a bid score for each tag bid value associated with the at least one advertisement tag;
generating, via the server, a click score according to a click-through-rate associated with the advertisement tag;
matching, via the server, at least one advertisement tag with one or more metadata image tags associated with the image;
generating, via the server, a metadata match score for each advertisement tag associated with the advertisement;
matching, via the server, at least one advertisement tag with one or more image recognition image tags associated with the image;
generating, via the server, an image recognition match score for each advertisement tag associated with the advertisement;
generating, via the server, an advertisement tag score for the at least one advertisement tag, wherein the advertisement tag score is generated according to at least one score selected from: the metadata match score, the image recognition match score, the bid score, the click score, and a combination thereof;
generating, via the server, a tag rank score associated with advertisement tag of the advertisement, according to the advertisement tag score and the tag bid value;
generating, via the server, an advertisement rank score according to the tag rank scores associated with each advertisement;
selecting, via the server, an advertisement for display based on the advertisement rank score;
embedding, via the server, the selected advertisement in an advertisement spot of the website; said selected advertisement is viewable on the website page displayed by a viewer device;
generating, via the server, a revenue-per-click value to provide payment when the advertisement is clicked upon by a viewer of the website.

2. The method of claim 1, wherein the server is configured to receive image tags from a website administrator device, said website administrator device is associated with a web administrator user interface for providing the image tags.

3. The method of claim 1, wherein the image tags are generated according to an object displayed in the image identified by an image recognition module.

4. The method of claim 1, wherein the advertiser user interface is associated with the advertiser device through a dedicated application.

5. The method of claim 1, wherein generation of the bid score comprises associating a scaled value to the tag bid value according to the tag bid values stored in an advertisement storage of the server.

6. The method of claim 1, wherein generating the click score comprises:
obtaining a click rate of the advertisement tag, said click rate is a number of times the advertisement associated with the advertisement tag was clicked by a viewer of the advertisement;
obtaining an impression value of the advertisement tag, said impression value is the number of times the advertisement associated with the advertisement tag is displayed on the website;
obtaining a click-through-ratio according to the click rate and the impression value;
associating a scaled value with the click-through-ratio, wherein scaled value is within a predetermined range.

7. The method of claim 1, wherein generation of the metadata match score comprises:
determining a number of advertisement tags matching the metadata image tags of the image;
generating a metadata match score based on the number of advertisement tags matching the metadata image tags of the image.

8. The method of claim 1, wherein generation of the image recognition match score comprises:
determining a number of advertisement tags matching the image recognition image tags of the image;
generating an image recognition match score based on the number of advertisement tags matching the image recognition image tags of the image.

9. The method of claim 1, wherein generation of the revenue-per-click value is calculated based on at least one parameter selected from: an advertisement tag score, a tag rank score, an advertisement rank score and a predetermined monetary value.

10. A system for selecting and displaying advertisements on a website, the system comprising:
a server configured to:
scan a website to obtain an image and image metadata embedded in the website;
analyze the image and the image metadata to locate characteristics identifying the image;
generate one or more image recognition image tags associated with the image, wherein the one or more image tags are generated according to image recognition analysis of the image;
generate one or more metadata image tags associated with the image, wherein the one or more image tags are generated according to the analysis of metadata related to the image;
provide an advertiser user interface displayed on an advertiser device for obtaining an advertisement, at least one associated advertisement tag, and a tag bid value associated with the advertisement tag;
receive the obtained advertisement from the advertiser device;
generate a bid score for each tag bid value associated with the at least one advertisement tag;
generate a click score according to a click-through-rate associated with the advertisement tag;
match at least one advertisement tag with one or more metadata image tags associated with the image;
generate a metadata match score for each advertisement tag associated with the advertisement;
match at least one advertisement tag with one or more image recognition image tags associated with the image;
generate an image recognition match score for each advertisement tag associated with the advertisement;
generate an advertisement tag score for the at least one advertisement tag, wherein the advertisement tag score is generated according to at least one score selected from: the metadata match score, the image recognition match score, the bid score, the click score, and a combination thereof;
generate a tag rank score associated with advertisement tag of the advertisement, according to the advertisement tag score and the tag bid value;
generate an advertisement rank score according to the tag rank scores associated with each advertisement;
select an advertisement for display based on the advertisement rank score;
embed the selected advertisement in an advertisement spot of the website; said selected advertisement is viewable on the website page displayed by a viewer device;
generate a revenue-per-click value to provide payment value when the advertisement is clicked upon by a viewer of the website.

11. The system of claim 10, wherein the server is configured to receive image tags from a website administrator device, said website administrator device is associated with a web administrator user interface for providing the image tags.

12. The system of claim 10, wherein the image tags are generated according to an object displayed in the image identified by an image recognition module.

13. The system of claim 10, wherein the advertiser user interface is associated with the advertiser device through a dedicated application.

14. The system of claim 10, wherein generation of the bid score comprises associating a scaled value to the tag bid value according to the tag bid values stored in an advertisement storage of the server.

15. The system of claim 10, wherein generating the click score comprises:
obtaining a click rate of the advertisement tag, said click rate is a number of times the advertisement associated with the advertisement tag was clicked by a viewer of the advertisement;
obtaining an impression value of the advertisement tag, said impression value is the number of times the advertisement associated with the advertisement tag is displayed on the website;
obtaining a click-through-ratio according to the click rate and the impression value;
associating a scaled value with the click-through-ratio, wherein scaled value is within a predetermined range.

16. The system of claim 10, wherein generation of the metadata match score comprises:
determining a number of advertisement tags matching the metadata image tags of the image;
generating a metadata match score based on the number of advertisement tags matching the metadata image tags of the image.

17. The system of claim 10, wherein generation of the image recognition match score comprises:
determining a number of advertisement tags matching the image recognition image tags of the image;
generating an image recognition match score based on the number of advertisement tags matching the image recognition image tags of the image.

18. The system of claim 10, wherein generation of the revenue-per-click value is calculated based on at least one parameter selected from: an advertisement tag score, a tag rank score, an advertisement rank score and a predetermined monetary value.
